(19) United States
(12) Patent Application Publication
(10) Pub. No.: US 2008/0071988 A1
(43) Pub. Date: Mar. 20, 2008

(54) Adaptable Caching Architecture and Data Transfer for Portable Devices

(75) Inventors: Philipp C. Schloter, San Francisco, CA (US); Matthias Jacob, London (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/855,424

(22) Filed: Sep. 14, 2007

Related U.S. Application Data
(60) Provisional application No. 60/825,923, filed on Sep. 17, 2006.

(51) Int. Cl. G06F 12/08; G06F 15/16

(52) U.S. Cl. 711/118; 709/231; 711/E12.02

(57) ABSTRACT

An apparatus for providing an improved caching architecture is provided. The apparatus may include a processing element configured to cache data in clusters based on respective features, receive an indication of data desired by a user, the indication further including a particular feature, search in a cluster corresponding to the particular feature, and stream, to the user, one or more candidate results corresponding to the received indication and the particular feature.

### CROSS-REFERENCE TO RELATED APPLICATIONS

The present application claims priority to U.S. Provisional Application No. 60/825,923 filed Sep. 17, 2006, the contents of which are incorporated by reference herein in their entirety.

### FIELD OF THE INVENTION

Embodiments of the present invention generally relate to mobile search technology and, more particularly, relate to methods, devices, mobile terminals and computer program products for combining an adaptable caching architecture with a data transfer mechanism to enable efficient and reliable information retrieval.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demands, while providing more flexibility and immediacy of information transfer.

Current and future networking technologies continue to facilitate ease of information transfer and convenience to users. One area in which there is a demand to increase ease of information transfer and convenience to users relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, video recorders, cameras, etc, or even from a combination of the mobile terminal and the network device. In this regard, various applications and software have been developed and continue to be developed in order to give the users robust capabilities to perform tasks, communicate, entertain themselves, gather and/or analyze information, etc. in either fixed or mobile environments.

Mobile applications based on searching applications may be important for enhancing and enabling mobile services. Currently, search algorithms and architecture have been developed mainly for personal computer (PC) devices. However, searching on mobile devices is very different than searching on a PC. Mobile devices often lack or have limitations with respect to various properties that a search system often needs, such as, limited hardware capabilities including processing power, memory, and bandwidth, slow and/or non-steady connections depending on the channel conditions, location based information due to the mobility, time sensitive information, etc. The mobile devices are often unusable or at best limited in their utility for information retrieval due to limited search algorithms and architectures. Efforts have been made, however, to improve search techniques with an improved visual search system being described in U.S. application Ser. No. 11/592,460, entitled “Scalable Visual Search System Simplifying Access to Network and Device Functionality,” the contents of which are hereby incorporated herein by reference in their entirety.

Enabling efficient and reliable information retrieval on a mobile device may be enhanced by improved information storage and information transfer strategies. In this regard, improving information storage may include providing a suitable and efficient caching strategy. A cache is a temporary storage area where frequently or recently accessed data can be stored for rapid access. Each cache entry may be defined by the data, i.e. the information to be stored, and a tag which specifies the identity of the data. For example, in the context of storing a web page, the URL is the tag and the contents of the web page are the data. The cache itself may be fully associative, set-associative or direct mapped. In a direct mapped cache every data item is assigned a unique location in the cache memory. In a set-associative cache the data is mapped to “n” different cache locations and in a fully associative cache the data can be stored in any cache location. When data is to be stored in a cache it may also be stored in the non-cache (storage) memory. Write operations to the cache can either be write-through or write-back. In a write-through cache, every write to the cache causes a write to the non-cache (storage) memory. Alternatively, in a write-back cache, writes to the non-cache (storage) memory are made when the data is evicted from the cache.

Information transfer strategies include strategies for transferring/receiving data as a stream or as single bursts with large data packets.

Given the increased applications for information search and data transfer on mobile terminal devices, there exists a need to develop an efficient and reliable information retrieval and transfer mechanism.

### BRIEF SUMMARY OF INVENTION

Systems, methods, devices and computer program products of the exemplary embodiments of the present invention relate to improved search technology and, more particularly, relate to methods, devices, mobile terminals and computer program products for combining an adaptable caching architecture with a data transfer mechanism to enable efficient and reliable information retrieval. Embodiments of the invention provide the users of, for example, mobile devices, having limited system capabilities, with a reliable, easy to use, information retrieval capability in various environments.

In one exemplary embodiment, a method of providing an improved caching architecture is provided. The method may include caching data in clusters based on respective features, receiving an indication of data desired by a user, the indication further including a particular feature, searching in a cluster corresponding to the particular feature, and streaming, to the user, one or more candidate results corresponding to the received indication and the particular feature.

In another exemplary embodiment, a computer program product for providing an improved caching architecture is provided. The computer program product includes at least one computer-readable storage medium having computer-readable program code portions stored therein. The computer-readable program code portions include first, second, third and fourth executable portions. The first executable portion is for caching data in clusters based on respective features. The second executable portion is for receiving an indication of data desired by a user, the indication further including a particular feature. The third executable portion is for searching in a cluster corresponding to the particular feature. The fourth executable portion is for streaming, to the user, one or more candidate results corresponding to the received indication and the particular feature.

In another exemplary embodiment, an apparatus for providing an improved caching architecture is provided. The apparatus may include a processing element configured to cache data in clusters based on respective features, receive an indication of data desired by a user, the indication further including a particular feature, search in a cluster corresponding to the particular feature, and stream, to the user, one or more candidate results corresponding to the received indication and the particular feature.

In another exemplary embodiment, an apparatus for providing an improved caching architecture is provided. The apparatus includes means for caching data in clusters based on respective features, means for receiving an indication of data desired by a user, the indication further including a particular feature, means for searching in a cluster corresponding to the particular feature, and means for streaming, to the user, one or more candidate results corresponding to the received indication and the particular feature.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a schematic block diagram of a system architecture according to an exemplary embodiment of the present invention;

FIG. 4 is a schematic block diagram of a mobile search cache architecture and data transfer mechanism according to an exemplary embodiment of the present invention;

FIG. 5 illustrates an example of managed tag-based server updates according to an exemplary embodiment;

FIG. 6 is a state diagram of data streaming according to an exemplary embodiment of the present invention; and

FIG. 7 is a flowchart illustrating a method of providing an adaptable data caching architecture according to an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

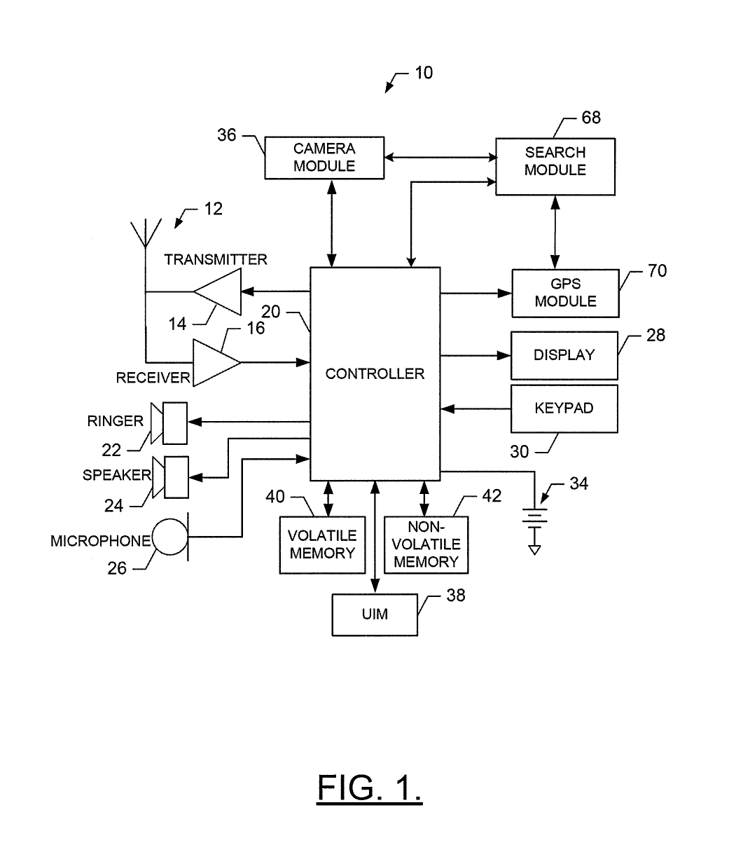

Referring now to FIG. 1, which illustrates a block diagram of a mobile terminal (device) 10 that would benefit from the present invention. It should be understood, however, that a mobile terminal as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDA's), pagers, mobile televisions, laptop computers and other types of voice and text communications systems, can readily employ the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes an apparatus, such as a controller 20 or other processing element, that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols including IS-136 (TDMA), GSM, and IS-95 (CDMA), third-generation (3G) wireless communication protocol including Wideband Code Division Multiple Access (WCDMA), Bluetooth (BT), IEEE 802.11, IEEE 802.15/16 and ultra wideband (UWB) techniques. The mobile terminal further may be capable of operating in a narrowband networks including AMPS as well as TACS.

It is understood that the apparatus, such as the controller 20, includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs and functionality to process information data, all which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a camera module 36 in communication with the controller 20. The camera module 36 may be any means for capturing an image or a video clip or video stream for storage, display or transmission. For example, the camera module 36 may include a digital camera capable of forming a digital image file from an object in view, a captured image or a video stream from recorded video data. The camera module 36 may be able to capture an image, read or detect bar codes, as well as other code-based data, OCR data and the like. As such, the camera module 36 includes all hardware, such as a lens, sensor, scanner or other optical device, and software necessary for creating a digital image file from a captured image or a video stream from recorded video data, as well as reading code-based data, OCR data and the like. Alternatively, the camera module 36 may include only the hardware needed to view an image, or video stream while memory devices 40, 42, including cache memory, of the mobile terminal 10 store instructions for execution by the controller 20 in the form of software necessary to create a digital image file from a captured image or a video stream from recorded video data, and information data for transmission or reception. In an exemplary embodiment, the camera module 36 may further include a processing element such as a co-processor which assists the controller 20 in processing image data, a video stream, or code-based data as well as OCR data and an encoder and/or decoder for compressing and/or decompressing image data, a video stream, code-based data, OCR data and the like. The encoder and/or decoder may encode and/or decode according to a JPEG standard format, and the like. Additionally, or alternatively, the camera module 36 may include one or more views such as, for example, a first person camera view and a third person map view.

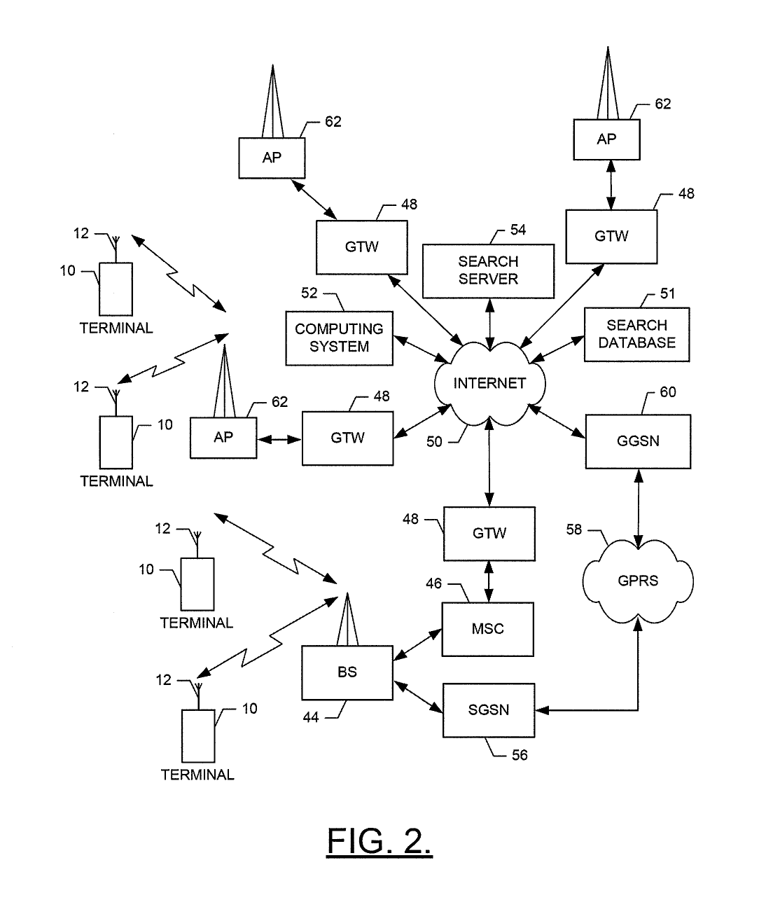

The mobile terminal 10 may further include a GPS module 70 and/or a search module 68 in communication with the controller 20. The GPS module 70 may be any means for locating the position of the mobile terminal 10. Additionally, the GPS module 70 may be any means for locating the position of point-of-interests (POIs), in images captured or read by the camera module 36, such as for example, shops, bookstores, restaurants, coffee shops, department stores, products, businesses, museums, historic landmarks etc. As such, points-of-interest as used herein may include any entity of interest to a user, such as products, other objects and the like and geographic places as described above. The GPS module 70 may include all hardware for locating the position of a mobile terminal or POI in an image. Alternatively or additionally, the GPS module 70 may utilize a memory device(s) 40, 42, including cache memory, of the mobile terminal 10 to store instructions for execution by the controller 20 in the form of software necessary to determine the position of the mobile terminal or an image of a POI or information data for transmission or reception. Additionally, the GPS module 70 is capable of utilizing the controller 20 to transmit/receive, via the transmitter 14/receiver 16, locational information such as the position of the mobile terminal 10, the position of one or more POI's, to a server, such as the search server 54 and the search database 51, as disclosed in FIG. 2 and described more fully below.

Referring now to FIG. 2, which illustrates a type of system that would benefit from the present invention. The system includes a plurality of network devices. As shown, one or more mobile terminals 10 may each include an antenna 12 for transmitting signals to and for receiving signals from a base site or base station (BS) 44 or access point (AP) 62. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52, search server 54, search database 51, or the like.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or server 54 may be coupled to the mobile terminal 10 via the Internet 50, SGSN 56 and GGSN 60. In this regard, devices such as the computing system 52 and/or server 54 may communicate with the mobile terminal 10 across the SGSN 56, GPRS core network 58 and the GGSN 60. By directly or indirectly connecting mobile terminals 10 and the other devices (e.g., computing system 52, server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), Wibree, infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like.

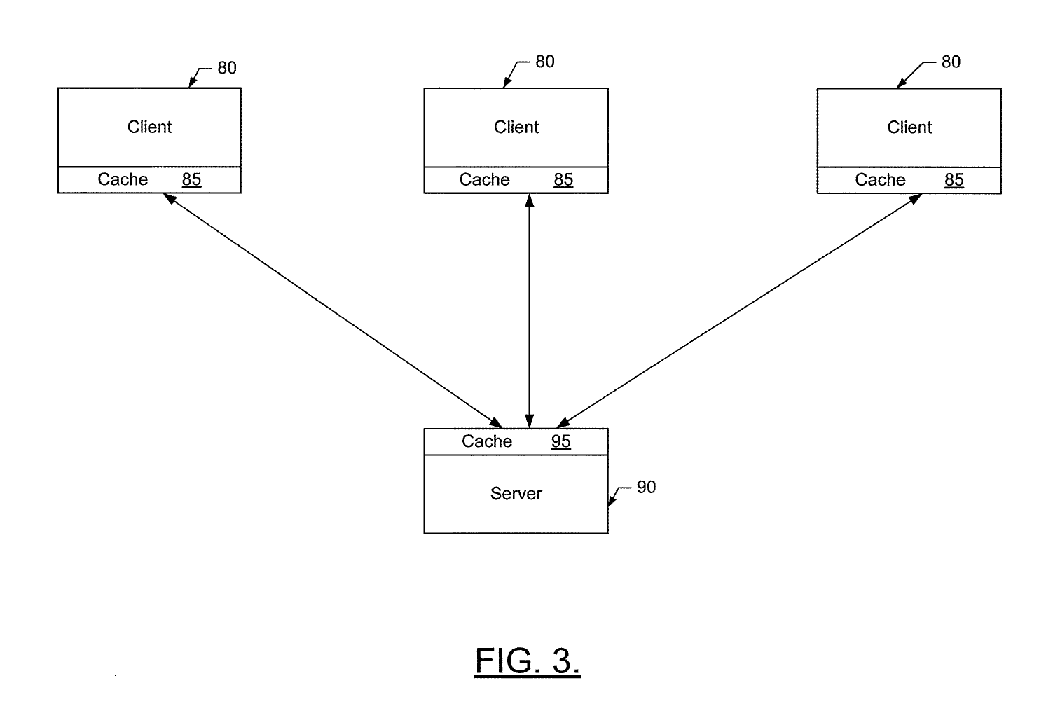

Referring now to FIG. 3, an illustration is provided of a system architecture according to an exemplary embodiment of the present invention. The system includes a plurality of clients 80, wherein the clients may each include the mobile terminal 10 as described in FIGS. 1 and 2, accessing a server 90, wherein the server may include the search server 54, search database 51 and/or computing system 52 as described in FIG. 2, so as to enable information retrieval. The clients 80 are either mobile or stationary while the server 90 is typically stationary. Furthermore, the server itself may not necessarily be a single physical computing device (as shown in FIG. 3, element 90) but can also be an interconnected cluster of computing devices (as is shown in FIG. 2, elements 52, 54, and 51) depending on bandwidth requirements so as to improve or optimize network traffic. Each of the clients 80 may store received information in their corresponding local cache 85 so as to reduce delay in execution of an application utilizing the received information and to reduce the impact of any interruptions due to connection outages. A server cache 95, which may serve as a local cache for the server 90, may store data therein that is preferably accessible quickly. The caches 85 and 95 may be fully associative, set-associative or direct mapped depending on the application and environment of the device comprising the cache. Caching strategies are often an important part of a server design in a mobile environment, since they affect the usability and performance of the application. Without a suitable cache strategy it may be difficult, if not impossible, to implement a reliable and efficient information retrieval application.

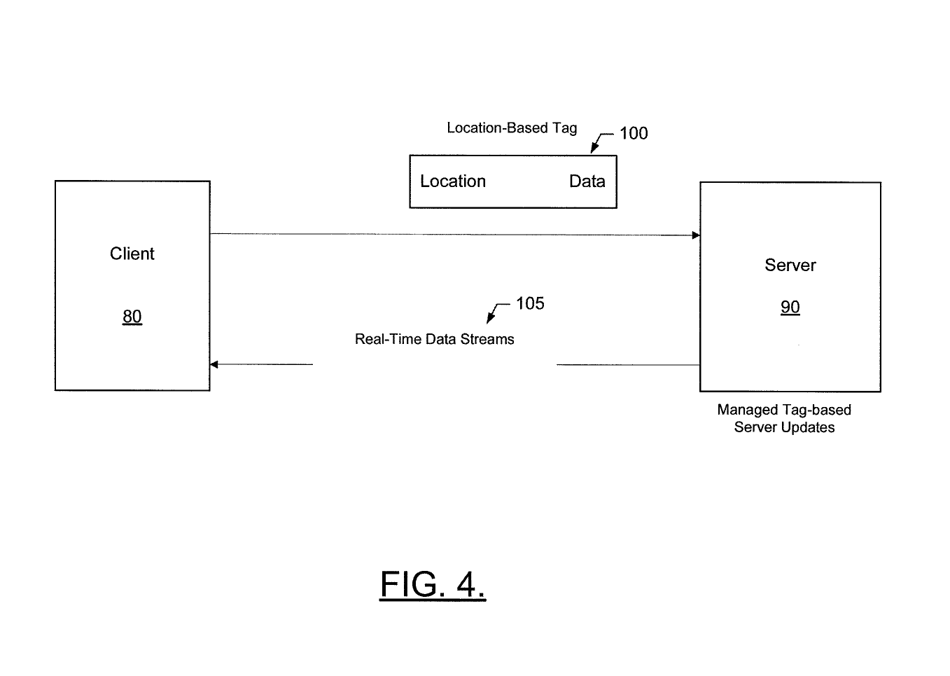

Referring now to FIG. 4, an illustration is provided of the building blocks of a search cache architecture and data transfer system according to an exemplary embodiment of the present invention. The three main building blocks of the search cache architecture (e.g., for a mobile visual search) and data transfer system comprise location/time-based tags, managed tag-based server updates, and real-time data streaming. Typically, a search may query information such as a keyword or a key image and in accordance with an exemplary embodiment of the present invention may also include location information from the client 80 in the form of a “key”, that may be sent by the client 80 to the server 90, in the form of, or as a portion of, a location-based tag 100 to assist the retrieval of desired information. In this regard, the location-based tag 100 may include information indicative of location (e.g., the location of the client 80 or device requesting the search) and data (e.g., the keyword forming the basis for the search). In accordance with an exemplary embodiment of the present invention, cache entries with the same location information may be clustered into one set of cache space (e.g., within the server cache 95), and therefore the location-based tag 100 may be considered to be set-associative. Thus, for example, if a user requests train schedule or weather information (e.g., data), the location-based tag 100 may further include location information indicative of the user's location (e.g., using the GPS module 70 or any other position sensor (e.g., cell ID, inertial sensors, etc.)) to enable the server 90 to access targeted portions of the server cache 95 that include information associated with the user's location to expedite the searching operation.

Furthermore, search query information in accordance with an exemplary embodiment of the present invention may also include time-sensitive information from the client 80 that may be sent by the client 80 to the server 90, in the form of, or as a portion of a time-based tag. In contrast to location-based tags, time-based tags may be direct-mapped in cache since only the “n” most recent instances of the information have to be available in the cache, wherein “n” is a predefined value.

As information is sent back and forth, the data in the server's non-volatile memory (storage) may need to be updated so as to enable the provision of updated information to the client in the future. When the client 80 is offline, the client 80 may store the data in its cache (e.g., local cache 85) and transmit the data to the server 90, for updating, when the connection is up again. Since the server 90 updates may take place in the background without delaying the application, the updates are usually write-through, unless the connection is offline when updating. Given location information the server may manage updates depending on the location “keys” and may add the new or updated entries to the actual non-cache (storage) memory. In an exemplary embodiment, the server 90 may determine, in a background operation (e.g., via a background thread), a fraction of total non-cache (storage) memory that is used and remove (e.g., by deletion) certain stored elements in accordance with a configured eviction strategy (e.g., deleting oldest data, least frequently used data, or some other priority order). When sufficient memory space is obtained, the background thread may stop.

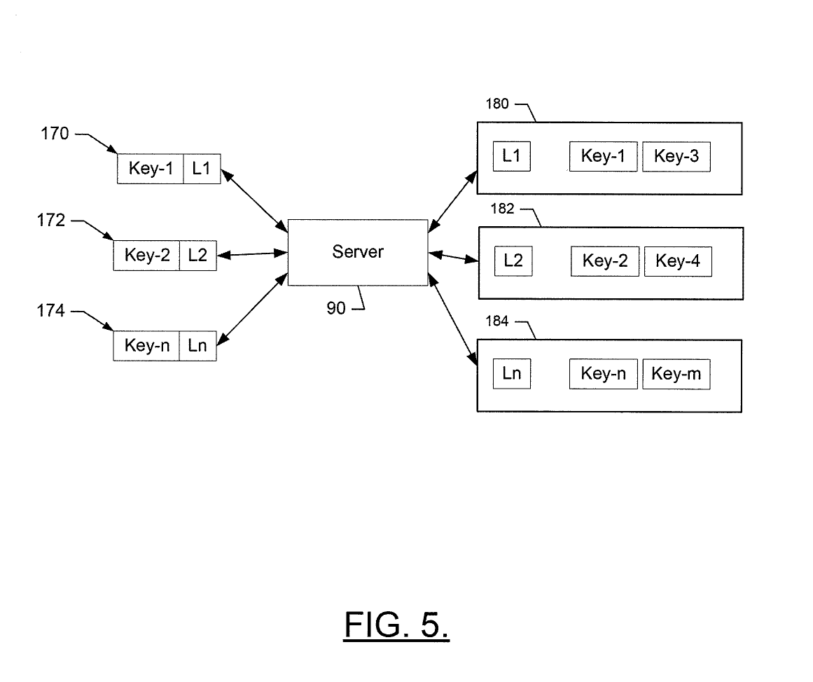

FIG. 5 illustrates an example of managed tag-based server updates according to an exemplary embodiment. As shown in FIG. 5, a plurality of keys (e.g., key-1, key-2, key-n) each having a corresponding location (L1, L2, Ln) forming respective first data 170, second data 172 and n data 174 may be received at the server 90. The server 90 may merge all entries with the same location-tag set into one set. In other words, for example, key-1 having a corresponding location, L1, may be merged or associated with other keys (e.g., key-3) having the same location (L1) and stored in a first cluster 180, while key-2 having a corresponding location, L2, may be merged or associated with other keys (e.g., key-4) having the same location (L2) and stored in a second cluster 182, while other keys are stored in a corresponding set (or location cluster (e.g. n cluster 184) within the server cache 95. Thus, when a client 80 conducts a search associated with a specific location, the server 90 may only search over a corresponding specified location cluster, thereby making the search system scalable. Furthermore, the server 90 may conduct all clustering operations of data sets in the background. Thus, for example, when data is in an image, the image may be converted into an image abstraction in the background and clustered with other image abstractions to assist in expediting future searches for images.

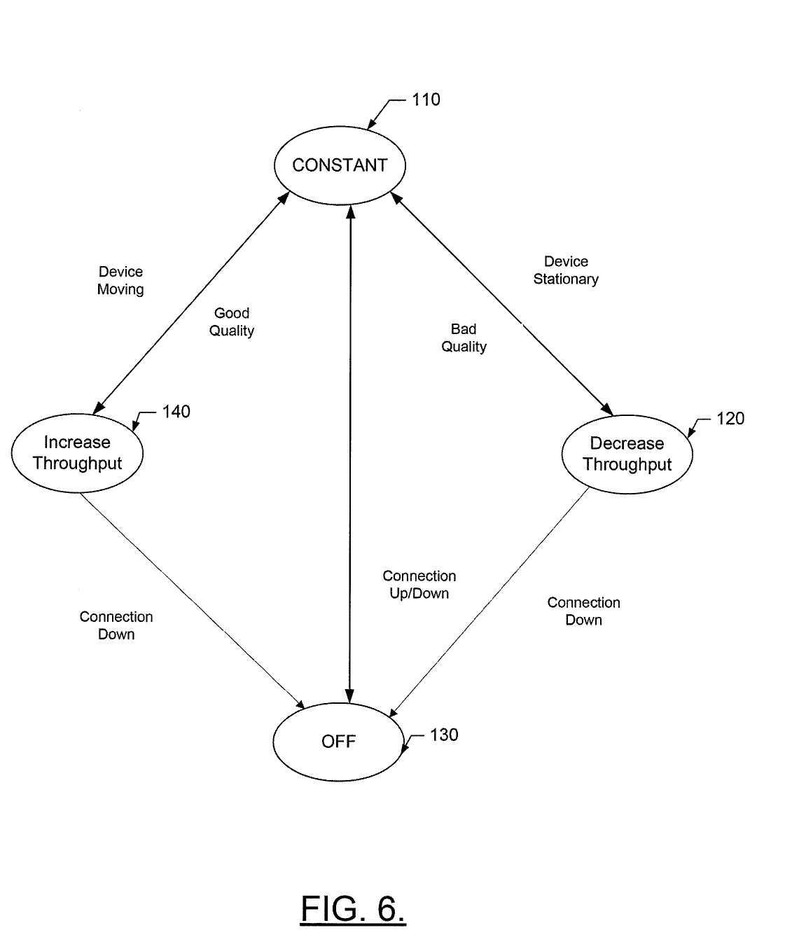

Reference is now made to FIG. 6, which is an illustration of a state diagram of data streaming according to an exemplary embodiment of the present invention. Since the search content in a mobile environment may be either location- or time-dependent it may be preferred to transfer the data as a steady real-time data stream 105 (as disclosed in reference to FIG. 4) instead of in a single burst with large data packets so as to provide up-to-date (e.g., in time and/or location) information. For example, when a client 80 is moved to a new location, new information (e.g., corresponding to the new location (e.g., weather/traffic information) or the current time (e.g., news information)) may be desired for transfer to the cache of the client 80. Additionally, a steady stream of data may be preferable to bursty transmissions due to bandwidth constraints and possible offline situations. Accordingly, it may be desirable for the client 80 to pre-fetch certain content that may be considered likely to be accessed in the future. For example, if a user changes to new location, the client 80 may expect (e.g., based on user preferences, search history, etc.) the user to request certain information that may be associated with the new location. Accordingly, the client 80 may pre-fetch corresponding information for the new location. In this regard, in some instances, the amount of data sent during a stream may depend on the data changes (e.g., the time interval at which news is updated, the speed at which the client 80 is moving geographically, etc.).

As illustrated in FIG. 6, when the client 80 is stationary, the stream throughput may decrease as indicated in operation 120 until the stream throughput drops to zero to remain constant as indicated at operation 110 (e.g., all information for the current location has been transferred). As the client 80 moves, the throughput may increase as indicated in operation 140. Movement of the client 80 may be defined in terms of the number of different locations the client 80 has visited over some interval of time.

Similar to the location of the client 80 the throughput may further depend on the connection quality (e.g., as measured by a number of errors, SNR, or other mechanisms). In this regard, for example, when the connection quality deteriorates, the server 90 may decrease the throughput as indicated in operation 120 and increase the throughput as indicated in operation 140 again as the connection quality improves. As the connection deteriorates to the extent that it goes down, the transmission may be terminated as indicated in operation 130.

Furthermore, the real-time stream can also be probabilistic and comprise multiple locations. When a mobile device is to move to an position “X” with probability “p” and to position “Y” with probability “q”, then “p” of “X's” data and “q” of “Y's” data may be pre-fetched so as to increase the speed and reliability of transfer of the desired information. For example, the server may send information to the client based on past queries, depending on the computed probability, even though the information may not have been queried. Furthermore, the server may send information to the client similar to or related to the information requested, depending on the computed probability that the information may be requested in the future.

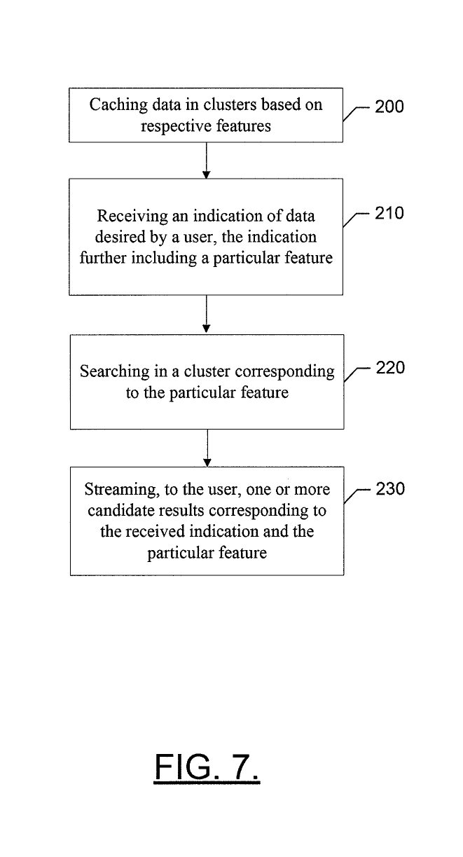

FIG. 7 is a flowchart of a method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a built-in processor in a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing an adaptable caching architecture as illustrated, for example, in FIG. 7, may include caching data in clusters based on respective features at operation 200. The features may include, for example, time and/or location. The method may further include receiving an indication of data desired by a user at operation 210. The indication may further include a particular feature. The indication may alternatively or additionally include location-based information or time-based information. In an exemplary embodiment, location based data may be cached as set-associative and time based data may be cached as direct-mapped. A cluster corresponding to the particular feature may be searched at operation 220. In an exemplary embodiment, the cluster corresponding to the particular feature may be the only cluster searched in order to reduce the amount of searching required to introduce scalability to the search system. Finally, at operation 230, one or more candidate results may be streamed to the user in which the candidate results correspond to the received indication and the particular feature. Accordingly, information retrieval may be made more efficient and reliable.

In an exemplary embodiment, streaming the candidate results to the user may include streaming at a variable throughput rate. The variable throughput rate may depend on a connection quality of a communication connection to the user or on a rate of movement of the user, for example, if the data desired is location sensitive information (e.g., location-based information). Streaming the candidate results to the user may also or alternatively include streaming results based on a computed probability such that the results may include data not explicitly requested. In at least some embodiments, caching data in clusters based on respective features may include merging data having a first feature into a first cluster and merging data having a second feature into a second cluster. Of note, clustering of a cache may occur at either or both of client and server caches.

Many modifications and other embodiments of the inventions set forth herein will come to mind to one skilled in the art to which these inventions pertain having the benefit of the teachings presented in the foregoing descriptions and the associated drawings. For example, although a client-server based architecture is described above, embodiments could also be practiced in other architectures as well (e.g., peer-to-peer). Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
caching data in clusters based on respective features;
receiving an indication of data desired by a user, the indication further including a particular feature;
searching in a cluster corresponding to the particular feature; and
streaming, to the user, one or more candidate results corresponding to the received indication and the particular feature.

2. The method of claim 1, wherein caching data in clusters based on respective features comprises caching data in clusters based on location or time and wherein the indication includes location-based information or time-based information.

3. The method of claim 2, wherein caching data further comprises caching location based data as set-associative and caching time based data as direct-mapped.

4. The method of claim 1, wherein caching data further comprises clustering of the data in the background.

5. The method of claim 1, wherein streaming the candidate results to the user further comprises streaming at a variable throughput depending on a connection quality of a communication connection to the user.

6. The method of claim 1, wherein streaming the candidate results to the user further comprises streaming at a variable throughput depending on a rate of movement of the user.

7. The method of claim 1, wherein streaming the candidate results to the user further comprises streaming results based on a computed probability such that the results may include data not explicitly requested.

8. The method of claim 1, wherein caching data in clusters based on respective features comprises merging data having a first feature into a first cluster and merging data having a second feature into a second cluster.

9. A computer program product comprising at least one computer-readable storage medium having computer-readable program code portions stored therein, the computer-readable program code portions comprising:
a first executable portion for caching data in clusters based on respective features;
a second executable portion for receiving an indication of data desired by a user, the indication further including a particular feature;
a third executable portion for searching in a cluster corresponding to the particular feature; and
a fourth executable portion for streaming, to the user, one or more candidate results corresponding to the received indication and the particular feature.

10. The computer program product of claim 9, wherein the first executable portion includes instructions for caching data in clusters based on location or time and wherein the indication includes location-based information or time-based information.

11. The computer program product of claim 10, wherein the first executable portion includes instructions for caching location based data as set-associative and caching time based data as direct-mapped.

12. The computer program product of claim 9, wherein the first executable portion includes instructions for clustering of the data in the background.

13. The computer program product of claim 9, wherein the fourth executable portion includes instructions for streaming at a variable throughput depending on a connection quality of a communication connection to the user.

14. The computer program product of claim 9, wherein the fourth executable portion includes instructions for streaming at a variable throughput depending on a rate of movement of the user.

15. The computer program product of claim 9, wherein the fourth executable portion includes instructions for streaming results based on a computed probability such that the results may include data not explicitly requested.

16. An apparatus comprising a processing element configured to:
cache data in clusters based on respective features;
receive an indication of data desired by a user, the indication further including a particular feature;
search in a cluster corresponding to the particular feature; and
stream, to the user, one or more candidate results corresponding to the received indication and the particular feature.

17. The apparatus of claim 16, wherein the processing element is further configured to cache data in clusters based on location or time, and wherein the indication includes location-based information or time-based information.

18. The apparatus of claim 17, wherein the processing element is further configured to cache location based data as set-associative and cache time based data as direct-mapped.

19. The apparatus of claim 16, wherein the processing element is further configured to cluster the data in the background.

20. The apparatus of claim 16, wherein the processing element is further configured to stream at a variable throughput depending on a connection quality of a communication connection to the user.

21. The apparatus of claim 16, wherein the processing element is further configured to stream at a variable throughput depending on a rate of movement of the user.

22. The apparatus of claim 16, wherein the processing element is further configured to stream results based on a computed probability such that the results may include data not explicitly requested.

23. The apparatus of claim 16, wherein the processing element is further configured to merge data having a first feature into a first cluster and merging data having a second feature into a second cluster.

24. An apparatus comprising:
means for caching data in clusters based on respective features;
means for receiving an indication of data desired by a user, the indication further including a particular feature;
means for searching in a cluster corresponding to the particular feature; and
means for streaming, to the user, one or more candidate results corresponding to the received indication and the particular feature.

25. The apparatus of claim 24, wherein means for caching data in clusters based on respective features comprises means for caching data in clusters based on location or time and wherein the indication includes location-based information or time-based information.
